(19) United States
(12) Patent Application Publication
(10) Pub. No.: US 2009/0056896 A1
(43) Pub. Date: Mar. 5, 2009

(54) AQUEOUS DISPERSION OF PRECIPITATED CALCIUM CARBONATE STARTING FROM AT LEAST ONE DISPERSING AGENT COMPRISING A COMPOUND CARRYING FLUORIDE IONS

(75) Inventors: Christian Jacquemet, Lyon (FR); Jacques Mongoin, Quincieux (FR)

Correspondence Address: OBLON, SPIVAK, MCCLELLAND MAIER & NEUSTADT, P.C., 1940 DUKE STREET, ALEXANDRIA, VA, 22314, US

(73) Assignee: COATEX S.A.S., Genay (FR)

(21) Appl. No.: 12/296,529

(22) PCT Filed: Apr. 4, 2007
(86) PCT No.: PCT/IB2007/000985

§ 371 Date: Oct. 9, 2008

(30) Foreign Application Priority Data
Apr. 14, 2006 (FR) 06 03325

(51) Int. Cl. D21H 17/37; C08K 3/26; C08K 3/10

(52) U.S. Cl. 162/168.1; 524/425; 524/413

(57) ABSTRACT

The object of the invention is the use as a dispersing agent, with a view to dispersing mineral matter containing precipitated calcium carbonate (PCC) in water, of a combination:
of at least one (meth)acrylic acid homopolymer and/or copolymer, and/or at least one phosphate compound, and/or at least one cationic polymer,
and of at least one fluoride ion-containing compound.

Another object of the invention lies in the aqueous suspensions of mineral matter containing PCC obtained in this manner, and in the dry pigments obtained by drying of the said suspensions.

A final object of the invention lies in the use of the above-mentioned suspensions and dry pigments in the manufacture of paper, and notably in the formulation of paper coatings and in the manufacture of paper sheet, in the manufacture of paints, plastics and rubbers.

A first object of the invention lies in the use as a dispersing agent, with a view to dispersing mineral matter containing precipitated calcium carbonate (PCC) in water, of a combination:
of at least one (meth)acrylic acid homopolymer and/or copolymer, and/or at least one phosphate compound, and/or at least one cationic polymer,
and of at least one fluoride ion-containing compound.

A second and third object of the invention lie in the aqueous suspensions of mineral matter containing PCC obtained in this manner, and in the dry pigments obtained by drying of the said suspensions.

A final object of the invention lies in the use of the above-mentioned suspensions and dry pigments in the manufacture of paper, and notably in the formulation of paper coatings and in the manufacture of paper sheet, in the manufacture of paints, plastics and rubbers.

Calcium carbonate, and more specifically precipitated calcium carbonate (PCC), is a filler commonly used in many applications such as plastics, paint, but also paper, notably giving the latter satisfactory optical and printing properties. PCC is a synthetic material, generally obtained by precipitation in water by reaction between carbon dioxide and lime; the result consists of an aqueous suspension of PCC.

The dry extract of the said aqueous suspension is defined as the percentage by dry weight of PCC relative to the total weight of the said suspension (this definition will be repeated throughout the present Application). In the aim of giving the user the greatest possible quantity of PCC per unit of volume, the skilled man in the art seeks to maximise this dry extract.

In addition, this aqueous suspension containing PCC, in the course of its shipment, will undergo a number of stages of transfer from one tank to another, notably by means of pumping operations. It is therefore necessary that the said dispersion is pumpable, which is reflected in a particular set of rheological properties: this constraint may be considered equivalent to obtaining as low as possible an immediate Brookfield™ viscosity, measured at 25° C. and at 100 RPM according to the method well known to the skilled man in the art. The Applicant indicates that throughout the remainder of the Application, the expression Brookfield™ viscosity will designate the immediate Brookfield™ viscosity measured at 25° C. and at 100 RPM, with the appropriate module, and according to the method well known to the skilled man in the art.

Deliberately, the Applicant has not indicated any particular value for the dry extract and for the Brookfield™ viscosity which the skilled man in the art is seeking, respectively, to maximise and to reduce. It is, indeed, firstly impossible to give general values, since these depend (among other things) on the crystalline structure of the envisaged PCC (the said PCC may be a rhombohedron, a scalenohedron, aragonite or vaterite), on its granulometric characteristics and on its specific surface area. Secondly, the Applicant does not wish to mislead the reader, by indicating particular values which might lead it to be believed that the search for the said values constitutes in itself the technical problem which the present Application seeks to resolve: the real technical problem addressed in the present Application will be indicated and described in detail in the following section.

With a view to increasing the dry extract and to reducing the Brookfield™ viscosity of the aqueous suspensions of PCC, the skilled man in the art is perfectly familiar with the addition to the said suspensions of a dispersing agent. As such, the skilled man in the art is familiar with a certain number of documents, the content and teachings of which will be presented in what follows.

Nevertheless, before reviewing this state of the art the Applicant wishes to define what the skilled man in the art understands by efficiency, in terms of dispersing agents. The skilled man in the art will be able to measure the efficiency of a dispersing agent which he uses with a view to dispersing particles of PCC in water, by the quantity of the said dispersing agent (expressed as a percentage by dry weight of dispersing agent relative to the total dry weight of PCC) required with a view to obtaining a given Brookfield™ viscosity and a given dry extract. In other words, the smaller the quantity required to be used to obtain a given dry extract and Brookfield™ viscosity the more efficient a dispersing agent; and this quantity is expressed as a percentage by dry weight of dispersing agent relative to the total dry weight of PCC. Thus, the problem which the present Application seeks to resolve may be defined as a search for PCC dispersing agents which are more efficient than those of the prior art: i.e. dispersing agents of which the skilled man in the art may use a smaller quantity than for the dispersing agents of the prior art, with a view to attaining a given dry extract and Brookfield™ viscosity, for the aqueous dispersion of PCC which he is seeking to obtain.

With a view to resolving this technical problem, the Applicant has a number of documents at its disposal, the content and teachings of which will now be described in detail.

Document EP 0 401 790 describes aqueous suspensions of mineral matter, produced through the addition of a polymer, notably a polymer of a cationic nature. The mineral matter in question is notably calcium carbonate, either in its natural form, or in its precipitated form (even if no example exists for PCC).

Document WO 99/61374 describes an aqueous suspension of precipitated calcium carbonate, the pH of which is stabilised at a value of under 9, and which has a positive zeta potential: by this means a suspension is obtained where the power of adhesion of the particles of PCC to the cellulose fibres is satisfactory. To this end, the proposed solution consists in the use of a monocarboxylic acid of formula A-COOH, where A designate hydrogen, or an alkyl radical having 1 to 8 carbon atoms. The examples indicate dry extracts equal to 30% of the total weight of the aqueous suspensions of PCC, and say nothing concerning the viscosities of such suspensions.

Document DE 10 253 812 describes an aqueous suspension of PCC and of calcium sulphate which are used in offset printing, where the said suspension also contains a dispersing agent and a grinding aid agent, which are chosen from among polyacrylates, polyvinylic alcohol, polycarboxylic acids, polysaccharides, and their derivatives. It is indicated that such a process enables easily pumpable suspensions to be obtained, while no viscosity measurement is indicated, having a high dry extract without any value being mentioned, and lastly enabling the energy yield of the dispersion process to be reduced by 60%: the document does not in fact contain any example which would enable these properties to be demonstrated, and is therefore of no assistance for the skilled man in the art.

Document EP 1 160 294 describes a process enabling an aqueous suspension of mineral particles to be obtained having a rheology which is improved both at a low speed gradient, which enables its dry extract be increased, and at a high speed gradient, which makes the products usable in paper coating machines working at high speed (by this means machinability is improved). This process relies on the use of a grinding stage using a grinder of the rotor-stator type. The suspension of mineral fillers is previously dispersed by means of phosphate compounds, polyacrylates, sulfonates, silicates and ligno-sulfates, the preferred dispersing agent being a sodium polyacrylate. However, this patent is based on the use of kaolin: all the examples, which give Brookfield™ and Hercules™ viscosity values, associated with dry extracts and sizes of particles, indeed concern kaolin, which is of no assistance for the skilled man in the art seeking to resolve the technical problem of the present invention relating to precipitated calcium carbonate.

Document WO 96/32448 describes a method to manufacture suspensions of PCC used subsequently in paper coatings, through the use of an anionic dispersing agent with a polycarboxylic acid base, such as a (meth)acrylic acid homo- or copolymer leading to a suspension, the dry extract of which is less than 30% of its weight, the addition of a cationic agent with a quaternary amines base to aggregate the particles of PCC, and finally the partial elimination of water leading to a final suspension the dry extract of which is greater than 60% of its weight. The examples which relate exclusively to natural calcium carbonate teach the skilled man in the art nothing concerning the use of this invention in connection with PCC.

Document KR 2003 60301 describes a method to prepare suspensions of PCC, by reaction in water of Ca(OH)₂ and of carbon dioxide, through formation of a filtration cake, the dry extract of which is between 35 and 40% of its weight, through the addition of a dispersing agent which is a polyacrylate, and by obtaining an aqueous suspension the dry extract of which is between 60 and 65% of its weight, which is stable over time, and which has a low viscosity.

Document WO 02/13774 describes an aqueous suspension of PCC which is usable in the formulation of dental pastes. This suspension notably contains an antimicrobial agent, and a dispersing agent in the preferred form of a combination of 0.1 to 0.7% by weight (relative to the dry weight of PCC) of sodium hexametaphosphate and of 0.8 to 1.2% by weight (relative to the dry weight of PCC) of sodium hypochlorite. The sole example demonstrates that it is possible to obtain, through the blending of 236 g of a suspension of PCC, the dry extract of which is equal to 20% of its weight, and of 3 kg of a cake of PCC, the dry extract of which is equal to 70% of its weight, a final suspension the dry extract of which is therefore equal to 66.4% (no mention is made of the granulometry of the PCC used), where the said suspension contains 0.4% by weight of sodium hexametaphosphate and 0.015% by weight of sodium hypochlorite. The suspension obtained in this manner has a Brookfield™ viscosity equal to 250 mPa·s.

Document WO 00/39029 describes a process enabling an aqueous suspension to be obtained from a carbonate material, and notably PCC, having a high dry extract, which is sufficiently fluid to be easily pumpable, and sufficiently viscous to prevent undesirable sedimentation phenomena. This process consists of a stage a) of suspension of the precipitated calcium carbonate with a dry extract of 40% maximum, a stage b) of partial elimination of water to attain a dry extract of between 45 and 65%, a stage c) of addition of a dispersing agent, a new stage d) of partial elimination of water, and finally a stage e) of mechanical treatment by blending at high speed, dissipating at least 1 kW/hour per ton of PCC. The sole example indicates that by this manner it is possible to obtain an aqueous suspension of PCC, 75% by weight of the particles of which have a diameter of less than 0.5 μm, with a dry extract equal to 71% of the total weight of the suspension, the viscosity of which remains stable for at least 7 days, and where the said suspension is easily manipulated and is notably pumpable. Although this example uses 0.5% by weight of a sodium polyacrylate (relative to the dry weight of PCC), the descriptive part of this document indicates that it is possible to use polymers containing at least one grouping of the carboxylic acid type (such as (meth)acrylic, itaconic, crotonic, fumaric, maleic, isocrotonic, angelic, undecylenic, hydroxy-acrylic, or maleic anhydride acid), where the said polymers have a molecular weight which is preferentially less than 20,000 g/mole.

The state of the art therefore demonstrates that no document sought to resolve the same technical problem as that forming the subject of the present Application. In addition, this state of the art demonstrates that the skilled man in the art commonly uses, with a view to dispersing PCC in water, acrylic acid homopolymers or copolymers, together with phosphate-based compounds, and cationic polymers.

Therefore, continuing its research with a view to dispersing PCC in water, with dispersing agents which are more efficient than those of the prior art (and notably more efficient than (meth)acrylic acid homopolymers or copolymers or phosphate compounds or cationic polymers), the Applicant has developed the use, as a dispersing agent, of a combination:
of at least one (meth)acrylic acid homopolymer and/or copolymer, and/or at least one phosphate compound, and/or at least one cationic polymer,
and of at least one fluoride ion-containing compound.

By the expression “fluoride ion-containing”, the Applicant means either a fluorinated mineral compound, or hydrofluoric acid, or a compound which is a fluoride of ammonium or of phosphonium.

In a completely surprising manner, this combination of at least one (meth)acrylic acid homopolymer and/or copolymer and/or of at least one phosphate compound and/or of at least one cationic polymer with a fluoride ion-containing compound, proves more efficient as an agent for dispersing mineral matter containing PCC in water than the simple use of a (meth)acrylic acid homopolymer and/or copolymer and/or of a phosphate compound and/or of a cationic polymer.

In other words, the quantity of dispersing agent according to the invention (the sum of the percentage by dry weight of the (meth)acrylic acid homopolymer and/or copolymer and/or of the phosphate compound and/or of the cationic polymer and of the percentage by dry weight of the fluoride ion-containing compound) is lower than the quantity of dispersing agent according to the prior art (percentage by dry weight of the (meth)acrylic acid homopolymer and/or copolymer and/or of the phosphate compound and/or of the cationic polymer), with a view to obtaining an aqueous dispersion of mineral matter containing PCC having a given dry extract and Brookfield™ viscosity, these percentages being given relative to the total dry weight of PCC used.

Without wishing to be bound to any theory, the Applicant believes that the fluoride ion-containing compound used in the composition of the dispersing agent according to the invention has, when it is brought into contact with the PCC, a high rate of reactivity to it. This hypothesis is supported by the extremely low value of the solubility product of fluorite (3.45 10⁻¹¹, according to the Handbook of Chemistry and Physics, 78^{th} Ed., 1997-1998) which must result from this reaction between the PCC and the fluoride ion-containing compound, thus favouring the formation of fluorite on the surface of the PCC. This precipitation reaction on the surface of the PCC gives rise to high-energy crystalline sites, by this means preparing the surface of the transformed mineral for a greater adsorption of the (meth)acrylic acid homopolymer and/or copolymer and/or of the phosphate compound and/or of the cationic polymer. The combination of these two factors enables the quantity of products used in the dispersing system to obtain a suspension of PCC with a given dry extract and Brookfield™ viscosity to be reduced.

One of the merits of the Applicant notably lies in the fact that it has been able to identify a particular compound, in the form of a fluoride ion-containing compound which, in association with a (meth)acrylic acid homopolymer and/or copolymer and/or a phosphate compound and/or a cationic polymer, enables the total quantity of dispersing agent used (as expressed previously) with a view to obtaining a given dry extract and Brookfield™ viscosity to be reduced.

This merit appears to be greater since the use of such fluoride ion-containing compounds is absolutely unknown in the state of the art relative to the dispersal in water of mineral matter containing PCC.

With a view to resolving a different technical problem, document U.S. Pat. No. 3,179,493 exists, which teaches the manufacture of a precipitated calcium carbonate, which is finely divided and of high purity, by reaction between a calcium salt and a carbonate compound, in the presence of a fluorinated compound chosen from among potassium, sodium and ammonium fluoride and silicofluoride. As for document U.S. Pat. No. 3,793,047, it teaches the surface treatment of a calcium carbonate by fluorinated compounds (H₂SiF₆ and MgSiF₆), with a view to obtaining opalescent particles which are resistant to abrasion and to acids.

Firstly, these patents are very far removed from the current problem of the skilled man in the art, since the technical problems covered are very different from the one mentioned in the present document. Secondly, in terms of the solutions adopted, the processes described in these two documents differ fundamentally from that of the present invention, since they are a process for manufacture of a calcium carbonate (U.S. Pat. No. 3,179,493) and a process for treatment of calcium carbonate (U.S. Pat. No. 3,793,047). Finally, the solutions used in these two documents also differ from that of the present invention, since they do not reveal the combination of a fluoride ion-containing compound with a (meth)acrylic acid homopolymer and/or copolymer.

Finally, the Applicant indicates that it is familiar with unpublished French patent application, filed as number 05/12928, which describes a process for manufacture of an aqueous dispersion of mineral matter comprising a first stage of grinding in an aqueous medium without a dispersing agent and/or grinding aid agent, followed by a stage of concentration, and characterised in that it uses a dispersing agent which is a combination of an acrylic acid homopolymer and a fluorinated mineral compound, before and/or during and/or after the concentration stage.

This process therefore initially uses a stage of grinding in an aqueous medium (i.e. for granulometric reduction of the size of the mineral particles), which is in no sense the case with the present invention.

Thus, a first object of the invention lies in the use as a dispersing agent, with a view to dispersing mineral matter containing precipitated calcium carbonate (PCC) in water, characterised in that the said dispersing agent is a combination:
of at least one (meth)acrylic acid homopolymer and/or copolymer, and/or at least one phosphate compound, and/or at least one cationic polymer,
and of at least one fluoride ion-containing compound,

This use is also characterised in that the said combination is used, with a view to dispersing mineral matter containing precipitated calcium carbonate (PCC) in water:
a) during a stage of dispersion in water of PCC initially introduced in the form of dry powder,
b) and/or during a stage of dispersion in water of a PCC filtration cake,
   c) and/or during a stage of concentration/dispersion of an aqueous suspension of PCC.

The use of a dispersing agent according to the invention is also characterised in that the fluoride ion-containing compound is chosen from among the ammonium and/or phosphonium fluorides and/or from among the compounds NaF, HF, KF, NaHF₂, H₂SiF₆, HKF₂, FeF₂, PbF₂, HNH₄F₂ and their blends, and preferentially from among the compounds NaF, HF, KF, H₂SiF₆, HKF₂, and their blends, and in that it is preferentially the compound NaF and HF and their blends.

The use of a dispersing agent according to the invention is also characterised in that the (meth)acrylic acid copolymer has at least one other monomer chosen from among at least:
a) another anionic monomer,
b) and/or at least one cationic monomer,
   c) and/or at least one non-ionic monomer,

Preferentially, the other anionic monomer a) is chosen from among an anionic monomer with ethylenic unsaturation and with a monocarboxylic function in the acid state or the acid-salt state, chosen from among the monomers with ethylenic unsaturation and a monocarboxylic function, and preferentially from among acrylic, methacrylic, crotonic, isocrotonic, cinnamic acid, or the diacid hemiesters such as the C₁ to C₄ monoesters of maleic or itaconic acids, or chosen from among the monomers with ethylenic unsaturation and with a dicarboxylic function in the acid or acid-salt state, and preferentially from among itaconic, maleic, fumaric, mesaconic acid, or again the anhydrides of carboxylic acids, such as maleic anhydride, or chosen from among the monomers with ethylenic unsaturation and a sulfonic function in the acid or acid-salt state, and preferentially from among acrylamido-2-methyl-2-propane-sulphonic acid, sodium methallylsulphonate, vinyl sulphonic acid and styrene sulphonic acid, or again chosen from among the monomers with ethylenic unsaturation and with a phosphoric function in the acid or acid-salt state such as vinyl phosphoric acid, ethylene glycol methacrylate phosphate, propylene glycol methacrylate phosphate, ethylene glycol acrylate phosphate, propylene glycol acrylate phosphate and their ethoxylates, or again chosen from among the monomers with ethylenic unsaturation and with a phosphonic function in the acid or acid-salt state, and is preferentially vinyl phosphonic acid, or their blends.

In a preferential manner, the cationic monomer b) is chosen from among the quaternary ammoniums, and preferentially from among [2-(methacryloyloxy)ethyl]trimethyl ammonium chloride or sulphate, [2-(acryloyloxy)ethyl]trimethyl ammonium chloride or sulphate, [3-(acrylamido)propyl]trimethyl ammonium chloride or sulphate, dimethyl diallyl ammonium chloride or sulphate, [3-(methacrylamido)propyl]trimethyl ammonium chloride or sulphate, or their blends.

In a preferential manner, the non-ionic monomer c) is chosen from among N-[3-(dimethylamino)propyl]acrylamide or N-[3-(dimethylamino)propyl]methacrylamide, the unsaturated esters such as N-[2-(dimethylamino)ethyl]methacrylate, or N-[2-(dimethylamino)ethyl]acrylate, or from among acrylamide or methacrylamide and their blends, the alkyl acrylates or methacrylates, the vinylic monomers, and preferentially vinyl acetate, vinylpyrrolidone, styrene, alphamethylstyrene and their derivatives, or the monomers of the following formula (I):

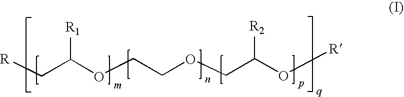

where:
   m and p represent a number of alkylene oxide units of less than or equal to 150,
   n represents a number of ethylene oxide units of less than or equal to 150,
   q represents a whole number at least equal to 1 and such that 5≦(m+n+p)q≦150, and preferentially such that 15≦(m+n+p)q≦120,
   R₁ represents hydrogen or the methyl or ethyl radical,
   R₂ represents hydrogen or the methyl or ethyl radical,
   R represents a radical containing an unsaturated polymerisable function, preferentially belonging to the group of vinylics, or to the group of acrylic, methacrylic, maleic, itaconic, crotonic or vinylphthalic esters, or to the group of unsaturated urethanes such as acrylurethane, methacrylurethane, α-α′ dimethyl-isopropenyl-benzylurethane, allylurethane, or to the group of allylic or vinylic ethers, whether or not substituted, or again to the group of ethylenically unsaturated amides or imides,
   R′ represents hydrogen or a hydrocarbonated radical having 1 to 40 carbon atoms.

The use of a dispersing agent according to the invention is also characterised in that the (meth)acrylic acid homopolymer and/or copolymer used is neutralised, totally or partially, by a neutralisation agent chosen from among the sodium or potassium hydroxides, the calcium or magnesium hydroxides and/or oxides, ammonium hydroxide, or their blends, preferentially by a neutralisation agent chosen from among sodium or potassium hydroxides, and very preferentially by a neutralisation agent which is sodium hydroxide.

The use of a dispersing agent according to the invention is also characterised in that the cationic polymer consists of at least one monomer chosen from among the quaternary ammoniums, and preferentially from among [2-(methacryloyloxy)ethyl]trimethyl ammonium chloride or sulphate, [2-(acryloyloxy)ethyl]trimethyl ammonium chloride or sulphate, [3-(acrylamido)propyl]trimethyl ammonium chloride or sulphate, dimethyl diallyl ammonium chloride or sulphate, [3-(methacrylamido)propyl]trimethyl ammonium chloride or sulphate, or their blends.

The use of a dispersing agent according to the invention is also characterised in that the phosphate compound is chosen from among the polyphosphates and preferentially from among the tripolyphosphates, or the hexametaphosphates or the pyrophosphates, of sodium or of potassium, or their blends.

The use of a dispersing agent according to the invention is also characterised in that between 0.1% and 5.0%, by dry weight relative to the dry weight of mineral matter, of at least one (meth)acrylic acid homopolymer and/or copolymer and/or of at least one phosphate compound and/or of at least one cationic polymer is used.

The use of a dispersing agent according to the invention is also characterised in that between 0.01% and 0.5%, and preferentially between 0.05% and 0.25%, by dry weight relative to the dry weight of mineral matter, of at least one fluoride ion-containing compound is used.

The use of a dispersing agent according to the invention is also characterised in that the fluoride ion-containing compound, firstly, and the (meth)acrylic acid homopolymer and/or copolymer and/or the phosphate compound, and/or the cationic polymer, secondly, are introduced simultaneously or in a sequential manner (sequential meaning that they are introduced one after another).

According to a variant, the use of a dispersing agent according to the invention is also characterised in that the fluoride ion-containing compound, firstly, and the (meth)acrylic acid homopolymer and/or copolymer, and/or the phosphate compound, and/or the cationic polymer, secondly, are introduced simultaneously, both in the form of an aqueous suspension and/or an aqueous solution and/or in the form of a dry powder, or are introduced simultaneously and in a blend, where the said blend is an aqueous suspension and/or an aqueous solution and/or a dry powder.

According to another variant, the use of a dispersing agent according to the invention is also characterised in that the fluoride ion-containing compound, firstly, is introduced in the form of a dry powder and/or in the form of an aqueous suspension and/or in the form of an aqueous solution, and in that the (meth)acrylic acid homopolymer and/or copolymer, and/or the phosphate compound, and/or the cationic polymer, secondly, is introduced in the form of an aqueous solution and/or in the form of dry powder when these two compounds are introduced sequentially, i.e. one after the other, whatever the order in which they are introduced.

The use of a dispersing agent according to the invention is also characterised in that the (meth)acrylic acid homopolymer and/or copolymer is obtained by known processes of radical polymerisation in solution, in a direct or reverse emulsion, in suspension or in precipitation in appropriate solvents, in the presence of known catalytic systems and transfer agents, or again by controlled radical polymerisation processes such as the method known as Reversible Addition Fragmentation Transfer (RAFT), the method known as Atom Transfer Radical Polymerization (ATRP), the method known as Nitroxide Mediated Polymerization (NMP), the method known as Macromolecular Design via Interchange of Xanthates (MADIX), or again the method known as Cobaloxime Mediated Free Radical Polymerization.

The use of a dispersing agent according to the invention is also characterised in that the (meth)acrylic acid homopolymer and/or copolymer may possibly, before or after its total or partial neutralisation, be treated and separated into several phases, according to static or dynamic processes known to the skilled man in the art, by one or more polar solvents belonging preferentially to the group constituted by water, methanol, ethanol, propanol, isopropanol, the butanols, acetone and tetrahydrofuran or their blends. One of the two phases then corresponds to the polymer used according to the invention.

The use of a dispersing agent according to the invention is also characterised in that the aqueous suspension of mineral matter containing PCC contains at least one PCC of the rhombohedron, scalenohedron, vateric, aragonitic type, or their blends.

The use of a dispersing agent according to the invention is also characterised in that the aqueous suspension of mineral matter containing PCC contains at least 2 PCCs of different granulometric characteristics, as measured using a Sedigraph™ 5100 device sold by the company MICROMERITICS™.

The use of a dispersing agent according to the invention is also characterised in that the aqueous suspension of mineral matter containing PCC possibly contains at least one other mineral matter chosen from among natural calcium carbonate, the dolomites, kaolin, talc, gypsum, lime, magnesia, titanium dioxide, satin white, aluminium trioxide, or again aluminium trihydroxide, the silicas, mica and a blend of these fillers one with another, such as talc-calcium carbonate blends, calcium carbonate-kaolin blends, or again blends of calcium carbonate with aluminium trihydroxide or aluminium trioxide, or again blends with synthetic or natural fibres, or again mineral costructures such as talc-calcium carbonate costructures or talc-titanium dioxide costructures, or their blends, and preferentially in that it is a natural calcium carbonate which is preferentially chosen from among marble, calcite, chalk or their blends.

In accordance with the PCC which he wishes to disperse in water, the skilled man in the art will know how to adapt the choice of dispersing system according to the invention.

More precisely, but without however binding the choice of a dispersing system according to the invention to a particular type of PCC, the skilled man in the art will be attentive:
firstly, to the molecular weight, to the polymolecularity index, to the neutralisation agent and to the rate of neutralisation of the phosphate compound and/or of the (meth)acrylic acid homopolymer or copolymer, in respect of the polymer used with the fluoride ion-containing compound,
secondly to the crystalline nature of the PCC (rhombohedron, scalenohedron, vateric, aragonitic), to the natural pH of the aqueous suspension formed when the said PCC is introduced into the water, to its specific surface area (measured according to the BET method using a device of the Flowsorb™ II type sold by the company MICROMERITICS™), to its granulometric characteristics such as, notably, its median diameter (measured according to a Sedigraph™ 5100 device sold by the company MICROMERITICS™).

Another object of the invention lies in the aqueous suspensions of mineral matter containing PCC, and also containing as a dispersing agent the combination:
of at least one (meth)acrylic acid homopolymer and/or copolymer, and/or at least one phosphate compound, and/or at least one cationic polymer,
and of at least one fluoride ion-containing compound.

The aqueous suspensions of mineral matter according to the invention are also characterised in that the fluoride ion-containing compound is chosen from among the ammonium and/or phosphonium fluorides and/or from among the compounds NaF, HF, KF, NaHF₂, H₂SiF₆, HKF₂, FeF₂, PbF₂, HNH₄F₂ and their blends, and preferentially from among the compounds NaF, HF, KF, H₂SiF₆, HKF₂, and their blends, and in that it is preferentially the compound NaF and HF and their blends.

The aqueous suspensions of mineral matter according to the invention are also characterised in that the (meth)acrylic acid copolymer has at least one other monomer chosen from among at least:
a) another anionic monomer,
b) and/or at least one cationic monomer,
c) and/or at least one non-ionic monomer,

Preferentially, the other anionic monomer a) is chosen from among an anionic monomer with ethylenic unsaturation and with a monocarboxylic function in the acid state or the acid-salt state, chosen from among the monomers with ethylenic unsaturation and a monocarboxylic function, and preferentially from among acrylic, methacrylic, crotonic, isocrotonic, cinnamic acid, or the diacid hemiesters such as the C₁ to C₄ monoesters of maleic or itaconic acids, or chosen from among the monomers with ethylenic unsaturation and with a dicarboxylic function in the acid or acid-salt state, and preferentially from among itaconic, maleic, fumaric, mesaconic acid, or again the anhydrides of carboxylic acids, such as maleic anhydride, or chosen from among the monomers with ethylenic unsaturation and a sulfonic function in the acid or acid-salt state, and preferentially from among acrylamido-2-methyl-2-propane-sulphonic acid, sodium methallylsulphonate, vinyl sulphonic acid and styrene sulphonic acid, or again chosen from among the monomers with ethylenic unsaturation and with a phosphoric function in the acid or acid-salt state such as vinyl phosphoric acid, ethylene glycol methacrylate phosphate, propylene glycol methacrylate phosphate, ethylene glycol acrylate phosphate, propylene glycol acrylate phosphate and their ethoxylates, or again chosen from among the monomers with ethylenic unsaturation and with a phosphonic function in the acid or acid-salt state, and is preferentially vinyl phosphonic acid, or their blends.

In a preferential manner, the cationic monomer b) is chosen from among the quaternary ammoniums, and preferentially from among [2-(methacryloyloxy)ethyl]trimethyl ammonium chloride or sulphate, [2-(acryloyloxy)ethyl]trimethyl ammonium chloride or sulphate, [3-(acrylamido)propyl]trimethyl ammonium chloride or sulphate, dimethyl diallyl ammonium chloride or sulphate, [3-(methacrylamido)propyl]trimethyl ammonium chloride or sulphate, or their blends.

In a preferential manner, the non-ionic monomer c) is chosen from among N-[3-(dimethylamino)propyl]acrylamide or N-[3-(dimethylamino)propyl]methacrylamide, the unsaturated esters such as N-[2-(dimethylamino)ethyl]methacrylate, or N-[2-(dimethylamino)ethyl]acrylate, or from among acrylamide or methacrylamide and their blends, the alkyl acrylates or methacrylates, the vinylic monomers, and preferentially vinyl acetate, vinylpyrrolidone, styrene, alphamethylstyrene and their derivatives, or the monomers of the following formula (I):

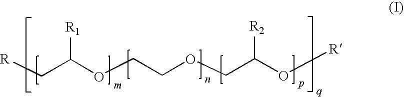

where:
   m and p represent a number of alkylene oxide units of less than or equal to 150,
   n represents a number of ethylene oxide units of less than or equal to 150,
   q represents a whole number at least equal to 1 and such that 5≦(m+n+p)q≦150, and preferentially such that 15≦(m+n+p)q≦120,
   R₁ represents hydrogen or the methyl or ethyl radical,
   R₂ represents hydrogen or the methyl or ethyl radical,
   R represents a radical containing an unsaturated polymerisable function, preferentially belonging to the group of vinylics, or to the group of acrylic, methacrylic, maleic, itaconic, crotonic or vinylphthalic esters, or to the group of unsaturated urethanes such as acrylurethane, methacrylurethane, α-α′ dimethyl-isopropenyl-benzylurethane, allylurethane, or to the group of allylic or vinylic ethers, whether or not substituted, or again to the group of ethylenically unsaturated amides or imides,
   R′ represents hydrogen or a hydrocarbonated radical having 1 to 40 carbon atoms.

The aqueous suspensions of mineral matter according to the invention are also characterised in that the (meth)acrylic acid homopolymer and/or copolymer used is neutralised, totally or partially, by a neutralisation agent chosen from among the sodium or potassium hydroxides, the calcium or magnesium hydroxides and/or oxides, ammonium hydroxide, or their blends, preferentially by a neutralisation agent chosen from among the sodium or potassium hydroxides, ammonium hydroxide, or their blends, and very preferentially by a neutralisation agent which is sodium hydroxide.

The aqueous suspensions of mineral matter according to the invention are also characterised in that the cationic polymer consists of at least one monomer chosen from among the quaternary ammoniums, and preferentially from among [2-(methacryloyloxy)ethyl]trimethyl ammonium chloride or sulphate, [2-(acryloyloxy)ethyl]trimethyl ammonium chloride or sulphate, [3-(acrylamido)propyl]trimethyl ammonium chloride or sulphate, dimethyl diallyl ammonium chloride or sulphate, [3-(methacrylamido)propyl]trimethyl ammonium chloride or sulphate, or their blends.

The aqueous suspensions of mineral matter according to the invention are also characterised in that the phosphate compound is chosen from among the polyphosphates and preferentially from among the tripolyphosphates, or the hexametaphosphates or the pyrophosphates, of sodium or of potassium, or their blends.

The aqueous suspensions of mineral matter according to the invention are also characterised in that they contain between 0.1% et 5.0%, by dry weight relative to the dry weight of mineral matter, of at least one (meth)acrylic acid homopolymer and/or copolymer and/or at least one phosphate compound and/or at least one cationic polymer.

The aqueous suspensions of mineral matter according to the invention are also characterised in that they contain between 0.01% and 0.5%, and preferentially between 0.05% and 0.25%, by dry weight relative to the dry weight of mineral matter, of at least one fluoride ion-containing compound.

The aqueous suspensions of mineral matter according to the invention are also characterised in that the (meth)acrylic acid homopolymer and/or copolymer is obtained by known processes of radical polymerisation in solution, in a direct or reverse emulsion, in suspension or in precipitation in appropriate solvents, in the presence of known catalytic systems and transfer agents, or again by controlled radical polymerisation processes such as the method known as Reversible Addition Fragmentation Transfer (RAFT), the method known as Atom Transfer Radical Polymerization (ATRP), the method known as Nitroxide Mediated Polymerization (NMP), the method known as Macromolecular Design via Interchange of Xanthates (MADIX), or again the method known as Cobaloxime Mediated Free Radical Polymerization.

The aqueous suspensions of mineral matter according to the invention are also characterised in that the (meth)acrylic acid homopolymer and/or copolymer may possibly, before or after its total or partial neutralisation, be treated and separated into several phases, according to static or dynamic processes known to the skilled man in the art, by one or more polar solvents belonging preferentially to the group constituted by water, methanol, ethanol, propanol, isopropanol, the butanols, acetone and tetrahydrofuran or their blends.

One of the phases then corresponds to the polymer used according to the invention.

The aqueous suspensions of mineral matter according to the invention are also characterised in that they contain at least one PCC of the rhombohedron, scalenohedron, vateric or aragonitic type, or their blends.

The aqueous suspensions of mineral matter according to the invention are also characterised in that they contain at least 2 PCCs of different granulometric characteristics, as measured using a Sedigraph™ 5100 device sold by the company MICROMERITICS™.

The aqueous suspensions of mineral matter according to the invention are also characterised in that they possibly contain at least a mineral matter other than PCC, chosen from among natural calcium carbonate, the dolomites, kaolin, talc, gypsum, lime, magnesia, titanium dioxide, satin white, aluminium trioxide, or again aluminium trihydroxide, the silicas, mica and a blend of these fillers one with another, such as talc-calcium carbonate blends, calcium carbonate-kaolin blends, or again blends of calcium carbonate with aluminium trihydroxide or aluminium trioxide, or again blends with synthetic or natural fibres, or again mineral costructures such as talc-calcium carbonate costructures or talc-titanium dioxide costructures, or their blends, and preferentially in that it is a natural calcium carbonate which is preferentially chosen from among marble, calcite, chalk or their blends.

The above-mentioned aqueous suspensions of mineral matter according to the invention can also undergo a stage of additional treatment, among those well-known to the skilled man in the art.

Thus, another object of the invention is a process to manufacture pigments containing PCC, characterised in that an aqueous suspension of mineral matter containing PCC according to the invention undergoes at least one additional treatment stage, chosen from among:
a stage of blending with another aqueous dispersion and/or suspension containing a mineral matter, which is preferentially natural calcium carbonate or kaolin, or their blends,
a grinding stage,
a stage of co-grinding with another mineral matter, which is preferentially natural calcium carbonate,
a stage of mechanical and/or thermal concentration,
a drying stage.

The produced dry pigments resulting from a stage of drying of the said aqueous suspensions of mineral matter also constitute another object of the present invention.

Another object of the invention lies in the uses of the above-mentioned aqueous suspensions of mineral matter containing PCC, and in those of the above-mentioned dry pigments, in a process to manufacture aqueous formulations of mineral matter or of dry products containing mineral matter.

Another object of the invention lies in the uses of the above-mentioned aqueous suspensions of mineral matter containing PCC, and in those of the above-mentioned dry pigments, in a process to manufacture paper coatings.

Another object of the invention lies in the uses of the above-mentioned aqueous suspensions of mineral matter containing PCC, and in those of the above-mentioned dry pigments, in a process to manufacture paper sheets.

Another object of the invention lies in the uses of the above-mentioned aqueous suspensions of mineral matter containing PCC, and in those of the above-mentioned dry pigments, in a process to manufacture paints.

Another object of the invention lies in the uses of the above-mentioned aqueous suspensions of mineral matter containing PCC and in those of the above-mentioned dry pigments, in a process to manufacture plastics or rubbers (it is self-evident that it is the dry pigments, in this case, and not the aqueous suspensions, which are used in the manufacture of the said dry products).

### EXAMPLES

In all the examples, the polymolecularity index and the molecular weight of the polymers used are determined according to the method explained below.

The molecular weight and the polymolecularity index are determined by a method of chromatography by stearic exclusion (CES), in the following manner. 1 mL of the polymer solution is put on a capsule, and then evaporated at ambient temperature in a vane pump vacuum. The solute is recovered by 1 mL of the eluent of the CES, and the whole is then injected in the CES equipment. The CES eluent is an NaHCO₃ solution: 0.05 mole/L, NaNO₃: 0.1 mole/L, triethylamine 0.02 mole/L, NaN₃ 0.03% by mass. The CES chain contains an isocratic pump (Waters™ 515) the flow rate of which is set at 0.5 mL/min, a kiln containing a pre-column of the “Guard Column Ultrahydrogel Waters™” type, a linear column measuring 7.8 mm internal diameter and 30 cm length, of the “Ultrahydrogel Waters™” type and a refractometric detector of the RI Waters™ 410 type. The kiln is heated to the temperature of 60° C., and the refractometer to 50° C. The application which detects and processes the chromatogram is the SECential application, supplied by “L.M.O.P.S. CNRS, Chemin du Canal, Vernaison, 69277”. The CES is calibrated by a series of 5 sodium poly(acrylate) standards supplied by Polymer Standards Service™.

### Example 1

This example illustrates the manufacture of an aqueous dispersion of precipitated calcium carbonate, through the formation of an aqueous suspension of PCC with a dry extract equal to 17% of its total weight, followed by formation of a filtration cake with a dry extract equal to 50% of its total weight, and finally dispersion of the said filtration cake:
according to the prior art, through the addition after the filtration cake formation stage, of a salt of the acrylic acid homopolymer,
according to the invention, through the addition after the stage of formation of the filtration cake of the same acrylic acid homopolymer, but in combination with a fluoride ion-containing compound.

### Tests N^{o} 1 and 2

These tests use, according to the method described in the preamble of example 1, a scalenohedral precipitated calcium carbonate, the specific surface area of which is equal to 6 m²/g (measured according to the BET method using a device of the Flowsorb™ II type sold by the company MICROMERITICS™) and the median diameter of which is equal to 2.70 μm (measured using a device of the Sedigraph™ 5100 type sold by the company MICROMERITICS™), together with:
0.33% by dry weight of an acrylic acid homopolymer (relative to the dry weight of PCC), totally neutralised by sodium hydroxide, of molecular weight equal to 12,000 g/mole, and of polymolecularity index equal to 2.2, in the case of test n^{o} 1 which illustrates the prior art,
0.20% by dry weight of an acrylic acid homopolymer (relative to the dry weight of PCC), totally neutralised by sodium hydroxide, of molecular weight equal to 12,000 g/mole, and of polymolecularity index equal to 2.2, and 0.05% by dry weight of sodium fluoride (relative to the dry weight of PCC), in the case of test n^{o} 2 which illustrates the invention.

For each of the tests n^{o} 1 and 2, the total quantity of dispersing agent, the dry extract of the final aqueous suspension of PCC, together with its Brookfield™ viscosity at 25° C. and at 100 RPM, are indicated in table 1.

TABLE 1

| | | | Dry extract of the aqueous | |
|---|---|---|---|---|
| | | | suspension of PCC (as a | Brookfield ™ viscosity |
| | | Quantity of dispersing | percentage by dry weight of | of the aqueous suspension |
| Test | Prior art/ | agent (by dry weight of | PCC/total weight of | of PCC (at 25° C. and |
| n° | Invention | agent/dry weight of PCC) | the suspension) | 100 RPM, mPa · s) |
| 1 | Prior art | 0.33 | 50.0 | 84 |
| 2 | Invention | 0.25 | 50.0 | 60 |

These results demonstrate that the use of a dispersing agent according to the invention enables a lesser quantity of dispersing agent to be used, compared to that used in the case of a dispersing agent of the prior art, with a view to obtaining a given dry extract and Brookfield™ viscosity (it is even noted that with the dispersing agent according to the invention an improved Brookfield™ viscosity is obtained, i.e. one lower than that obtained in the case of the prior art).

### Tests N^{o} 3 and 4

These tests use, according to the method described in the preamble of example 1, a rhombohedral precipitated calcium carbonate, the specific surface area of which is equal to 15.6 m²/g (measured according to the BET method using a device of the Flowsorb™ II type sold by the company MICROMERITICS™) and the median diameter of which is equal to 1.7 μm (measured using a device of the Sedigraph™ 5100 type sold by the company MICROMERITICS™), together with:
0.60% by dry weight of an acrylic acid homopolymer (relative to the dry weight of PCC), totally neutralised by sodium hydroxide, of molecular weight equal to 12,000 g/mole, and of polymolecularity index equal to 2.2, in the case of test n^{o} 3 which illustrates the prior art,
0.40% by dry weight of an acrylic acid homopolymer (relative to the dry weight of PCC), totally neutralised by sodium hydroxide, of molecular weight equal to 12,000 g/mole, and of polymolecularity index equal to 2.2, and 0.20% by dry weight of sodium fluoride (relative to the dry weight of PCC), in the case of test n^{o} 4 which illustrates the invention.

For each of the tests n^{o} 3 and 4, the total quantity of dispersing agent, the dry extract of the final aqueous suspension of PCC, together with its Brookfield viscosity at 25° C. and at 100 RPM, are indicated in table 2.

TABLE 2

| | | | Dry extract of the aqueous | |
|---|---|---|---|---|
| | | | suspension of PCC (as a | Brookfield ™ viscosity |
| | | Quantity of dispersing | percentage by dry weight of | of the aqueous suspension |
| Test | Prior art/ | agent (by dry weight of | PCC/total weight of | of PCC (at 25° C. and |
| n° | Invention | agent/dry weight of PCC) | the suspension) | 100 RPM, mPa · s) |
| 3 | Prior art | 0.60 | 50.0 | 520 |
| 4 | Invention | 0.60 | 50.0 | 360 |

These results demonstrate that the use of a dispersing agent according to the invention enables a quantity of dispersing agent equal to that used in the case of a dispersing agent of the prior art to be used, with a view to obtaining a dry extract equal to that obtained in the case of the prior art, but with a lower Brookfield™ viscosity: the dispersing agent according to the invention is therefore more efficient than the dispersing agent of the prior art.

### Tests N^{o} 5 to 9

These tests use, according to the method described in the preamble of example 1, a rhombohedral precipitated calcium carbonate, the specific surface area of which is equal to 10.9 m²/g (measured according to the BET method using a device of the Flowsorb™ II type sold by the company MICROMERITICS™) and the median diameter of which is equal to 1.8 μm (measured using a device of the Sedigraph 5100 type sold by the company MICROMERITICS™), together with:
0.80% by dry weight of an acrylic acid homopolymer (relative to the dry weight of PCC), totally neutralised by sodium hydroxide, of molecular weight equal to 12,000 g/mole, and of polymolecularity index equal to 2.2, in the case of test n^{o} 5 which illustrates the prior art,
1.00% by dry weight of an acrylic acid homopolymer (relative to the dry weight of PCC), totally neutralised by sodium hydroxide, of molecular weight equal to 10,000 g/mole, and of polymolecularity index equal to 3.1, in the case of test n^{o} 6 which illustrates the prior art,
0.54% by dry weight of an acrylic acid homopolymer (relative to the dry weight of PCC), totally neutralised by sodium hydroxide, of molecular weight equal to 10,000 g/mole, and of polymolecularity index equal to 3.1, and 0.28% by dry weight of sodium chloride (relative to the dry weight of PCC), in the case of test n^{o} 7 which is a reference not corresponding to the invention, but which illustrates the use of a polyacrylate with a compound which is not a fluoride ion-containing compound,
0.45% by dry weight of an acrylic acid homopolymer (relative to the dry weight of PCC), totally neutralised by sodium hydroxide, of molecular weight equal to 12,000 g/mole, and of polymolecularity index equal to 2.2, and 0.20% by dry weight of sodium fluoride (relative to the dry weight of PCC), in the case of test n^{o} 8 which illustrates the invention,
0.54% by dry weight of an acrylic acid homopolymer (relative to the dry weight of PCC), totally neutralised by sodium hydroxide, of molecular weight equal to 10,000 g/mole, and of polymolecularity index equal to 3.1, and 0.20% by dry weight of sodium fluoride (relative to the dry weight of PCC), in the case of test n^{o} 9 which illustrates the invention.

For each of the tests n^{o} 5 to 9, the total quantity of dispersing agent, the dry extract of the final aqueous suspension of PCC, together with its Brookfield viscosity at 25° C. and at 100 RPM, are indicated in table 3.

TABLE 3

| | | | Dry extract of the aqueous | |
|---|---|---|---|---|
| | | | suspension of PCC (as a | Brookfield ™ viscosity |
| | | Quantity of dispersing | percentage by dry weight of | of the aqueous suspension |
| Test | Prior art/ | agent (by dry weight of | PCC/total weight of | of PCC (at 25° C. and |
| n° | Invention | agent/dry weight of PCC) | the suspension) | 100 RPM, mPa · s) |
| 5 | Prior art | 0.80 | 50.0 | 625 |
| 6 | Prior art | 1.00 | 50.0 | 465 |
| 7 | Reference | 0.82 | 50.0 | 2,920 |
| 8 | Invention | 0.65 | 50.0 | 295 |
| 9 | Invention | 0.74 | 50.0 | 80 |

These results demonstrate that the use of a dispersing agent according to the invention enables a lesser quantity of dispersing agent to be used, compared to that used in the case of a dispersing agent of the prior art and in the case of the reference, with a view to obtaining a dry extract comparable to that obtained in connection with the prior art and with the reference, and a Brookfield™ viscosity which is even lower than that obtained with the dispersing agent of the prior art or of the reference.

### Example 2

This example illustrates the manufacture of an aqueous dispersion of precipitated calcium carbonate, through the aqueous formation of an aqueous suspension of PCC with a dry extract equal to 20% of its total weight, followed by formation of a filtration cake with a dry extract equal to 38% of its total weight, and finally dispersion of the said filtration cake:
according to the prior art, through the addition after the filtration cake formation stage, of a salt of the acrylic acid homopolymer,
according to the invention, through the addition after the stage of formation of the filtration cake of the same acrylic acid homopolymer, but in combination with a fluoride ion-containing compound.

### Tests N^{o} 10 and 11

These tests use, according to the method described in the preamble of example 2, a precipitated calcium carbonate used in ink-jet printing, the specific surface area of which is equal to 64 m²/g (measured according to the BET method using a device of the Flowsorb™ II type sold by the company MICROMERITICS™) and the diameter of which is equal to 4.15 μm (measured using a device of the Sedigraph 5100 type sold by the company MICROMERITICS™), together with:
3.35% by dry weight of an acrylic acid homopolymer (relative to the dry weight of PCC), totally neutralised by sodium hydroxide, of molecular weight equal to 12,000 g/mole, and of polymolecularity index equal to 2.2, in the case of test n^{o} 10 which illustrates the prior art,
2.9% by dry weight of an acrylic acid homopolymer (relative to the dry weight of PCC), totally neutralised by sodium hydroxide, of molecular weight equal to 12,000 g/mole, and of polymolecularity index equal to 2.2, and 0.20% by dry weight of sodium fluoride (relative to the dry weight of PCC), in the case of test n^{o} 11 which illustrates the invention.

For each of the tests n^{o} 10 and 11, the total quantity of dispersing agent, the dry extract of the final aqueous suspension of PCC, together with its Brookfield viscosity at 25° C. and at 100 RPM, are indicated in table 4.

TABLE 4

| | | | Dry extract of the aqueous | |
|---|---|---|---|---|
| | | | suspension of PCC (as a | Brookfield ™ viscosity |
| | | Quantity of dispersing | percentage by dry weight of | of the aqueous suspension |
| Test | Prior art/ | agent (by dry weight of | PCC/total weight of | of PCC (at 25° C. and |
| n° | Invention | agent/dry weight of PCC) | the suspension) | 100 RPM, mPa · s) |
| 10 | Prior art | 3.35 | 38.0 | 500 |
| 11 | Invention | 3.10 | 38.0 | 460 |

These results demonstrate that the use of a dispersing agent according to the invention enables a lesser quantity of dispersing agent, compared to that used in the case of a dispersing agent of the prior art, to be used with a view to obtaining a given dry extract and Brookfield™ viscosity.

### Example 3

This example illustrates the manufacture of an aqueous dispersion of precipitated calcium carbonate, through aqueous formation of an aqueous suspension of PCC with a dry extract equal to 34% of its total weight:
according to the prior art, through the addition of sodium hexametaphosphate,
according to the invention, through the addition of sodium hexametaphosphate, in combination with a fluoride ion-containing compound.

### Tests N^{o} 12 and 13

These tests use, according to the method described in the preamble of example 1, a precipitated calcium carbonate sold by the company SOLVAY™ with the name Socal™ P3, together with:
0.18% by dry weight of sodium hexametaphosphate, in the case of test n^{o} 12 which illustrates the prior art,
0.13% by dry weight of sodium hexametaphosphate, and of 0.05% by dry weight of sodium fluoride, in the case of test n^{o} 13 which illustrates the invention.

For each of the tests n^{o} 12 and 13, the total quantity of dispersing agent, the dry extract of the final aqueous suspension of PCC, together with its Brookfield viscosity at 25° C. and at 100 RPM, are indicated in table 5.

TABLE 5

| | | | Dry extract of the aqueous | |
|---|---|---|---|---|
| | | | suspension of PCC (as a | Brookfield ™ viscosity |
| | | Quantity of dispersing | percentage by dry weight of | of the aqueous suspension |
| Test | Prior art/ | agent (by dry weight of | PCC/total weight of | of PCC (at 25° C. and |
| n° | Invention | agent/dry weight of PCC) | the suspension) | 100 RPM, mPa · s) |
| 12 | Prior art | 0.18 | 34.0 | 1,200 |
| 13 | Invention | 0.18 | 34.0 | 1,000 |

These results demonstrate that the use of a dispersing agent according to the invention enables a quantity of dispersing agent equal to that used in the case of a dispersing agent of the prior art to be used, with a view to obtaining an identical dry extract but a lower Brookfield™ viscosity in the case of the invention.

### Example 4

This example illustrates the manufacture of an aqueous dispersion of precipitated calcium carbonate, through the formation of an aqueous suspension of PCC with a dry extract equal to 17% of its total weight, followed by formation of a filtration cake with a dry extract equal to 50% of its total weight, and finally dispersion of the said filtration cake:
according to the prior art, through the addition after the filtration cake formation stage, of a salt of the acrylic acid homopolymer,
according to the invention, through the addition after the stage of formation of the filtration cake of the same acrylic acid homopolymer salt, but in combination with a fluoride ion-containing compound.

The purpose of this example is notably to illustrate the special case in which the fluorinated mineral compound and the acrylic acid homopolymer are introduced simultaneously. It is indicated that, in all the other examples supporting the present application, the fluorinated mineral compound is introduced before the acrylic acid homopolymer or copolymer, or the cationic polymer or the phosphate compound.

### Tests N^{o} 14 and 15

These tests use, according to the method described in the preamble of example 1, a scalenohedral PCC of specific surface area equal to 6 m²/g (measured according to the BET method using a device of the Flowsorb™ II type sold by the company MICROMERITICS™) and of median diameter equal to 2.70 μm (measured using a device of the Sedigraph™ 5100 type sold by the company MICROMERITICS™), together with:
0.33% by dry weight of an acrylic acid homopolymer, totally neutralised by sodium hydroxide, of molecular weight equal to 12,000 g/mole and of polymolecularity index equal to 2.2: this is test n^{o} 1 which illustrates the prior art, and which has been renumbered as test n^{o} 14 for simpler reading of the tests,
0.20% by dry weight (relative to the dry weight of PCC) of the same acrylic acid homopolymer as the one used in test n^{o} 14, and 0.05% by dry weight (relative to the dry weight of PCC) of sodium fluoride, in the case of test n^{o} 15 which illustrates the invention.

For each of the tests n^{o} 14 and 15, the total quantity of dispersing agent, the dry extract of the final aqueous suspension of PCC, together with its Brookfield™ viscosity at 25° C. and at 100 RPM, are indicated in table 6.

TABLE 6

| | | | Dry extract of the aqueous | |
|---|---|---|---|---|
| | | | suspension of PCC (as a | Brookfield ™ viscosity |
| | | Quantity of dispersing | percentage by dry weight of | of the aqueous suspension |
| Test | Prior art/ | agent (by dry weight of | PCC/total weight of | of PCC (at 25° C. and |
| n° | Invention | agent/dry weight of PCC) | the suspension) | 100 RPM, mPa · s) |
| 14 | Prior art | 0.33 | 50.0 | 84 |
| 15 | Invention | 0.25 | 50.0 | 62 |

These results demonstrate that the use of a dispersing agent according to the invention enables a lesser quantity of dispersing agent to be used, compared to that used in the case of a dispersing agent of the prior art, with a view to obtaining a given dry extract and an improved Brookfield™ viscosity, i.e. one which is lower than that obtained in the case of the prior art.

### Example 5

This example illustrates the manufacture of an aqueous dispersion of PCC carbonate, through the formation of an aqueous suspension of PCC with a dry extract equal to 17% of its total weight, followed by formation of a filtration cake with a dry extract equal to 50% of its total weight, and finally dispersion of the said filtration cake:
according to the prior art, through the addition after the stage of formation of the filtration cake of a cationic polymer,
according to the invention, through the addition after the stage of formation of the filtration cake of the same cationic polymer, but in combination with a fluoride ion-containing compound.

### Tests N^{o} 16 to 18, and 16 Bis to 18 Bis

These tests use, according to the method described in the preamble of example 1, a scalenohedral PCC of specific surface area equal to 10.7 m²/g (measured according to the BET method using a device of the Flowsorb™ II type sold by the company MICROMERITICS™) and of median diameter equal to 1.43 μm (measured using a device of the Sedigraph™ 5100 type sold by the company MICROMERITICS™), together with:
0.50% by dry weight (relative to the dry weight of PCC) of a cationic polymer which is poly diallyldimethyl ammonium chloride, totally neutralised by ammonium hydroxide, of molecular weight equal to 305,300 g/mole, and of polymolecularity index equal to 4.7, in the case of test n^{o} 16 which illustrates the prior art,
0.23% by dry weight (relative to the dry weight of PCC) of the same cationic polymer as the one used for test n^{o} 16, and 0.20% by dry weight (relative to the dry weight of PCC) of potassium fluoride, in the case of test n^{o} 16 bis which illustrates the invention,
0.50% by dry weight (relative to the dry weight of PCC) of a cationic polymer which is a copolymer of 2-methacryloyl oxyethyl trimethyl ammonium chloride and of methacrylamidopropyltrimethyl ammonium chloride (95/5 as a molar %), totally neutralised by an ammonium hydroxide, of molecular weight equal to 91,400 g/mole and of polymolecularity index equal to 4.7, in the case of test n^{o} 17 which illustrates the prior art,
0.23% by dry weight (relative to the dry weight of PCC) of the same cationic polymer as the one used in the course of test n^{o} 17, and 0.20% by dry weight (relative to the dry weight of PCC) of potassium fluoride, in the case of test n^{o} 17 bis which illustrates the invention,
0.50% by dry weight (relative to the dry weight of PCC) of an acrylic acid copolymer and methacrylamidopropyltrimethyl ammonium chloride copolymer (26/74 as a molar %), totally neutralised by ammonium hydroxide, of molecular weight equal to 40,450 g/mole, and of polymolecularity index equal to 1.9, in the case of test n^{o} 18 which illustrates the prior art,
0.23% by dry weight (relative to the dry weight of PCC) of the same polymer as the one used in the course of test n^{o} 18, and 0.20% by dry weight (relative to the dry weight of PCC) of potassium fluoride, in the case of test n^{o} 18 bis which illustrates the invention.

For each of these tests, the total quantity of dispersing agent, the dry extract of the final aqueous suspension of PCC, together with its Brookfield™ viscosity at 25° C. and at 100 RPM, are indicated in table 7.

TABLE 7

| | | | Dry extract of the aqueous | |
|---|---|---|---|---|
| | | | suspension of PCC (as a | Brookfield ™ viscosity |
| | | Quantity of dispersing | percentage by dry weight of | of the aqueous suspension |
| Test | Prior art/ | agent (by dry weight of | PCC/total weight of | of PCC (at 25° C. and |
| n° | Invention | agent/dry weight of PCC) | the suspension) | 100 RPM, mPa · s) |
| 16 | Prior art | 0.50 | 50.0 | 17,800 |
| 16 bis | Invention | 0.43 | 50.0 | 14,600 |
| 17 | Prior art | 0.50 | 50.0 | 13,700 |
| 17 bis | Invention | 0.43 | 50.0 | 11,000 |
| 18 | Prior art | 0.50 | 50.0 | 8,400 |
| 18 bis | Invention | 0.43 | 50.0 | 7,000 |

These results demonstrate that the use of a dispersing agent according to the invention enables a lesser quantity of dispersing agent to be used, compared to that used in the case of a dispersing agent of the prior art, with a view to obtaining a given dry extract and an improved Brookfield™ viscosity, i.e. one which is lower than that obtained in the case of the prior art.

### Example 6

This example illustrates the manufacture of an aqueous dispersion of precipitated calcium carbonate (PCC) and natural calcium carbonate (GCC), by co-grinding between:
an aqueous dispersion of PCC obtained according to the prior art (use of an acrylic polymer) or according to the invention (use of sodium fluoride and of the same acrylic polymer),
and an aqueous dispersion of GCC containing an acrylic dispersing agent.

One begins by preparing an aqueous suspension of GCC according to the methods well known to the skilled man in the art, using 0.27% by dry weight of a polyacrylate relative to the dry weight of GCC. This suspension has a dry extract equal to 74.6% (expressed as a percentage by dry weight of GCC relative to the total weight of the suspension) and has granulometric characteristics such that 40.3% by weight of the particles of GCC have a diameter of less than 1 μm, 61.6% by weight of the particles of GCC have a diameter of less than 2 μm, and such that the median diameter of the particles of GCC is equal to 1.4 μm.

An aqueous suspension of PCC is also prepared using the methods well known to the skilled man in the art. This suspension has a dry extract equal to 14.1% (expressed as a percentage by dry weight of PCC relative to the total weight of the suspension) and has granulometric characteristics such that 83.3% by weight of the particles of PCC have a diameter of less than 1 μm, 97.8% by weight of the particles of PCC have a diameter of less than 2 μm, and such that the median diameter of the said particles of PCC is equal to 0.58 μm.

It contains:
0.6% by dry weight (relative to the dry weight of PCC) of an acrylic acid homopolymer, totally neutralised by sodium hydroxide, of molecular weight equal to 12,000 g/mole, and of polymolecularity index equal to 2.2, in the case of test n^{o} 19 which illustrates the prior art,
0.4% by dry weight (relative to the dry weight of PCC) of the same homopolymer as in test n^{o} 19, in combination with 0.2% by dry weight (relative to the dry weight of PCC) of H₂SiF₆, in the case of test n^{o} 20 which illustrates the invention,
0.4% by dry weight (relative to the dry weight of PCC) of the same homopolymer as in test n^{o} 19, in combination with 0.2% by dry weight (relative to the dry weight of PCC) of NaF in the case of test n^{o} 21 which illustrates the invention.

These suspensions of GCC and of PCC are then co-ground (the dry weight ratio GCC:PCC during this stage is equal to 50:50). During this stage a quantity of co-grinding agent equal to 0.4% by dry weight relative to the total dry weight of GCC and PCC is introduced. This agent is an acrylic acid homopolymer, of molecular weight equal to 5,700 g/mole, 26% of the carboxylic sites of which per mole have been neutralised by sodium hydroxide, and of polymolecularity index equal to 2.15.

The aqueous suspension of co-ground GCC and PCC obtained after afterwards is concentrated, by introducing the same agent as the one used during the co-grinding stage; the quantity of the said agent used during the stage of concentration is equal to 0.4% by dry weight relative to the total dry weight of GCC and PCC.

For each of these tests, the total quantity of dispersing agent of the PCC, the dry extract of the final aqueous suspension of co-ground PCC and GCC, together with its Brookfield™ viscosity at 25° C. and at 100 RPM, are indicated in table 8.

TABLE 8

| | | | Dry extract of the aqueous | |
|---|---|---|---|---|
| | | | suspension of co-ground PCC | |
| | | | and GCC (as a percentage | Brookfield ™ viscosity |
| | | Quantity of dispersing | by dry weight of PCC + | of the aqueous suspension |
| Test | Prior art/ | agent (by dry weight of | GCC/total weight of | of PCC and GCC (at 25° C. |
| n° | Invention | agent/dry weight of PCC) | the suspension) | and 100 RPM, mPa · s) |
| 19 | Prior art | 0.60 | 74.0 | 2,100 |
| 20 | Invention | 0.60 | 74.0 | 2,050 |
| 21 | Invention | 0.60 | 74.0 | 2,000 |

These results demonstrate that the use of a dispersing agent according to the invention enables a identical quantity of dispersing agent to be used, compared to that used in the case of a dispersing agent of the prior art, with a view to obtaining a given dry extract and a Brookfield™ viscosity lower than that obtained in the case of the prior art.

### Example 7

This example illustrates the manufacture of an aqueous dispersion of PCC and of kaolin.

One begins by forming an aqueous suspension of PCC with a dry extract equal to 17% of its total weight, and then proceeds by forming a filtration cake with a dry extract equal to 50% of its total weight.

Kaolin is then added such that the PCC/kaolin weight ratio is equal to 90/10.

Finally the entire blend is dispersed:
according to the prior art, through the addition after the stage of formation of the filtration cake, of an acrylic polymer,
according to the invention, through the addition after the stage of to formation of the filtration cake of the same acrylic polymer, but in combination with a fluoride ion-containing compound.

### Tests N^{o} 22 and 23

These tests use, according to the method described in the preamble of example 1, a scalenohedral PCC of specific surface area equal to 10.7 m²/g (measured according to the BET method using a device of the Flowsorb™ II type sold by the company MICROMERITICS™) and of median diameter equal to 1.43 μm (measured using a device of the Sedigraph™ 5100 type sold by the company MICROMERITICS™), together with:
0.80% by dry weight of an acrylic acid homopolymer (relative to the dry weight of PCC and of kaolin), totally neutralised by sodium hydroxide, of molecular weight equal to 12,000 g/mole, and of polymolecularity index equal to 2.2, in the case of test n^{o} 22 which illustrates the prior art,
0.40% by dry weight of the same polymer as the one used for test n^{o} 22, and 0.20% by dry weight of potassium fluoride (relative to the dry weight of PCC and kaolin), in the case of test n^{o} 23 which illustrates the invention.

For each of these tests, the total quantity of dispersing agent, the dry extract of the final aqueous suspension of PCC and of kaolin, together with its Brookfield™ viscosity at 25° C. and at 100 RPM, are indicated in table 9.

TABLE 9

| | | | Dry extract of the aqueous | |
|---|---|---|---|---|
| | | Quantity of dispersing | suspension of co-ground PCC | Brookfield ™ viscosity |
| | | agent (% by dry weight | and kaolin (as a % by dry | of the aqueous suspension |
| Test | Prior art/ | of agent/dry weight of | weight of PCC + kaolin/total | of PCC and kaolin (at 25° C. |
| n° | Invention | PCC + kaolin) | weight of the suspension) | and 100 RPM, mPa · s) |
| 22 | Prior art | 0.50 | 50.0 | 80 |
| 23 | Invention | 0.43 | 50.0 | 70 |

These results demonstrate that the use of a dispersing agent according to the invention enables a lesser quantity of dispersing agent to be used, compared to that used in the case of a dispersing agent of the prior art, with a view to obtaining a given dry extract and an improved Brookfield™ viscosity, i.e. one which is lower than that obtained in the case of the prior art.

### Example 8

This example illustrates the manufacture of an aqueous dispersion of precipitated calcium carbonate, through the formation of an aqueous suspension of PCC with a dry extract equal to 17% of its total weight, followed by formation of a filtration cake with a dry extract equal to 50% of its total weight, and finally dispersion of the said filtration cake according to the invention, through the addition after the stage of formation of the filtration cake of an acrylic copolymer, in combination with a fluoride ion-containing compound.

### Tests N^{o} 24 to 27

These tests use, according to the method described in the preamble of example 1, a scalenohedral PCC of specific surface area equal to 10.7 m²/g (measured according to the BET method using a device of the Flowsorb™ II type sold by the company MICROMERITICS™) and of median diameter equal to 1.43 μm (measured using a device of the Sedigraph™ 5100 type sold by the company MICROMERITICS™), together with:
in the case of test n^{o} 24 which illustrates the invention, 2.6% by dry weight (relative to the dry weight of PCC) of trihydrated tetrabutylammonium fluoride, in combination with 0.60% by dry weight (relative to the dry weight of PCC) of a copolymer of molecular weight equal to 31,600 g/mole, of polymolecularity index equal to 2, totally neutralised by sodium hydroxide, and consisting of (expressed as a % by weight of each of the monomers):
14% of acrylic acid,
5% of methacrylic acid,
81% of a monomer of formula (I) in which R₁ and R₂ represent hydrogen, R represents the methacrylate group, R′ represents the methyl radical, and with (m+n+p)q=45,
in the case of test n^{o} 25, 2.6% by dry weight (relative to the dry weight of PCC) of trihydrated tetrabutylammonium fluoride, in combination with 0.60% by dry weight (relative to the dry weight of PCC) of the same copolymer as the one used in test n^{o} 24, but not neutralised,
in the case of test n^{o} 26, 2.6% by dry weight (relative to the dry weight of PCC) of trihydrated tetrabutylammonium fluoride, in combination with 0.60% by dry weight of a copolymer (relative to the dry weight of PCC), totally neutralised by sodium hydroxide, of molecular weight equal to 12,000 g/mole and of polymolecularity index equal to 1.9, and consisting 90% by weight of acrylic acid and 10% by weight of methacrylic acid,
in the case of test n^{o} 27, 2.6% by dry weight (relative to the dry weight of PCC) of trihydrated tetrabutylammonium fluoride, in combination with 0.60% by dry weight (relative to the dry weight of PCC) of the same copolymer as the one used in test n^{o} 26, but obtained by a controlled radical polymerisation process of the RAFT type (as described in document FR 2 821 620).

For each of these tests, the total quantity of dispersing agent, the dry extract of the final aqueous suspension of PCC, together with its Brookfield™ viscosity at 25° C. and at 100 RPM, are indicated in table 10.

TABLE 10

| | Quantity of | Dry extract of the | Brookfield ™ |
|---|---|---|---|
| | dispersing | aqueous suspension of | viscosity of |
| | agent (by dry | PCC (as a percentage | the aqueous |
| | weight of | by dry weight of | suspension of PCC |
| Test | agent/dry | PCC/total weight of | (at 25° C. and |
| n° | weight of PCC) | the suspension) | 100 RPM, mPa · s) |
| 24 | 3.2 | 50.0 | 70 |
| 25 | 3.2 | 50.0 | 75 |
| 26 | 3.2 | 50.0 | 60 |
| 27 | 3.2 | 50.0 | 65 |

These results demonstrate that the use of a dispersing agent according to the invention enables aqueous suspensions of PCC to be obtained having a very low Brookfield™ viscosity; the same experiments, but without dispersing agent, did not enable aqueous suspensions of PCC which are easily manipulated by the user to be obtained.

Finally, the Applicant indicates that, in all the tests of the present Application and illustrating the invention, the fluoride ion-containing compounds are in the form of an aqueous solution, except for sodium fluoride, which is in the form of a dry powder.

1. Use as a dispersing agent, with a view to dispersing mineral matter containing precipitated calcium carbonate (PCC) in water, characterised in that the said dispersing agent is a combination:
of at least one (meth)acrylic acid homopolymer and/or copolymer, and/or at least one phosphate compound, and/or at least one cationic polymer,
and of at least one fluoride ion-containing compound.

2. Use according to claim 1, characterised in that the said combination is used, with a view to dispersing mineral matter containing precipitated calcium carbonate (PCC) in water:
a) during a stage of dispersion in water of PCC initially introduced in the form of dry powder,
b) and/or dispersion in water of a PCC filtration cake,
c) and/or during a stage of concentration/dispersion of an aqueous suspension of PCC.

3. Use according to claim 1, characterised in that the fluoride ion-containing compound is chosen from among the ammonium and/or phosphonium fluorides and/or from among the compounds NaF, HF, KF, NaHF₂, H₂SiF₆, HKF₂, FeF₂, PbF₂, HNH₄F₂ and their blends, and preferentially from among the compounds NaF, HF, KF, H₂SiF₆, HKF₂, and their blends, and in that it is preferentially the compound NaF and HF and their blends.

4. Use according to claim 1, characterised in that the (meth)acrylic acid copolymer has at least one other monomer chosen from among at least:
a) another anionic monomer,
b) and/or at least one cationic monomer,
c) and/or at least one non-ionic monomer,

5. Use according to claim 4, characterised in that the other anionic monomer a) is chosen from among an anionic monomer with ethylenic unsaturation and with a monocarboxylic function in the acid state or the acid-salt state, chosen from among the monomers with ethylenic unsaturation and a monocarboxylic function, and preferentially from among acrylic, methacrylic, crotonic, isocrotonic, cinnamic acid, or the diacid hemiesters such as the C₁ to C₄ monoesters of maleic or itaconic acids, or chosen from among the monomers with ethylenic unsaturation and with a dicarboxylic function in the acid or acid-salt state, and preferentially from among itaconic, maleic, fumaric, mesaconic acid, or again the anhydrides of carboxylic acids, such as maleic anhydride, or chosen from among the monomers with ethylenic unsaturation and a sulfonic function in the acid or acid-salt state, and preferentially from among acrylamido-2-methyl-2-propane-sulphonic acid, sodium methallylsulphonate, vinyl sulphonic acid and styrene sulphonic acid, or again chosen from among the monomers with ethylenic unsaturation and with a phosphoric function in the acid or acid-salt state such as vinyl phosphoric acid, ethylene glycol methacrylate phosphate, propylene glycol methacrylate phosphate, ethylene glycol acrylate phosphate, propylene glycol acrylate phosphate and their ethoxylates, or again chosen from among the monomers with ethylenic unsaturation and with a phosphonic function in the acid or acid-salt state, and is preferentially vinyl phosphonic acid, or their blends.

6. Use according to claim 4, characterised in that the cationic monomer b) is chosen from among the quaternary ammoniums, and preferentially from among [2-(methacryloyloxy)ethyl]trimethyl ammonium chloride or sulphate, [2-(acryloyloxy)ethyl]trimethyl ammonium chloride or sulphate, [3-(acrylamido)propyl]trimethyl ammonium chloride or sulphate, dimethyl diallyl ammonium chloride or sulphate, [3-(methacrylamido)propyl]trimethyl ammonium chloride or sulphate, or their blends.

7. Use according to claim 4, characterised in that the non-ionic monomer c) is chosen from among N-[3-(dimethylamino)propyl]acrylamide or N-[3-(dimethylamino)propyl]methacrylamide, the unsaturated esters such as N-[2-(dimethylamino)ethyl]methacrylate, or N-[2-(dimethylamino)ethyl]acrylate, or from among acrylamide or methacrylamide and their blends, the alkyl acrylates or methacrylates, the vinylic monomers, and preferentially vinyl acetate, vinylpyrrolidone, styrene, alphamethylstyrene and their derivatives, or the monomers of the following formula (I): 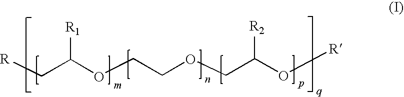
where:
m and p represent a number of alkylene oxide units of less than or equal to 150,
n represents a number of ethylene oxide units of less than or equal to 150,
q represents a whole number at least equal to 1 and such that 5≦(m+n+p)q≦150, and preferentially such that 15≦(m+n+p)q≦120,
R₁ represents hydrogen or the methyl or ethyl radical,
R₂ represents hydrogen or the methyl or ethyl radical,
R represents a radical containing an unsaturated polymerisable function, preferentially belonging to the group of vinylics, or to the group of acrylic, methacrylic, maleic, itaconic, crotonic or vinylphthalic esters, or to the group of unsaturated urethanes such as acrylurethane, methacrylurethane, α-α′ dimethyl-isopropenyl-benzylurethane, allylurethane, or to the group of allylic or vinylic ethers, whether or not substituted, or again to the group of ethylenically unsaturated amides or imides,
R′ represents hydrogen or a hydrocarbonated radical having 1 to 40 carbon atoms.

8. Use according to claim 1, characterised in that the (meth)acrylic acid homopolymer and/or copolymer used is neutralised, totally or partially, by a neutralisation agent chosen from among the sodium or potassium hydroxides, the calcium or magnesium hydroxides and/or oxides, ammonium hydroxide, or their blends, preferentially by a neutralisation agent chosen from among the sodium or potassium hydroxides, ammonium hydroxide, or their blends, and very preferentially by a neutralisation agent which is sodium hydroxide.

9. Use according to claim 1, characterised in that the cationic polymer consists of at least one monomer chosen from among the quaternary ammoniums, and preferentially from among [2-(methacryloyloxy) ethyl]trimethyl ammonium chloride or sulphate, [2-(acryloyloxy)ethyl]trimethyl ammonium chloride or sulphate, [3-(acrylamido)propyl]trimethyl ammonium chloride or sulphate, dimethyl diallyl ammonium chloride or sulphate, [3-(methacrylamido)propyl]trimethyl ammonium chloride or sulphate, or their blends.

10. Use according to claim 1, characterised in that the phosphate compound is chosen from among the polyphosphates and preferentially from among the tripolyphosphates, or the hexametaphosphates or the pyrophosphates, of sodium or of potassium, or their blends.

11. Use according to claim 1, characterised in that between 0.1% and 5.0%, by dry weight relative to the dry weight of mineral matter, of at least one (meth)acrylic acid homopolymer and/or copolymer and/or of at least one phosphate compound and/or of at least one cationic polymer is used.

12. Use according to claim 1, characterised in that between 0.01% and 0.5%, and preferentially between 0.05% and 0.25%, by dry weight relative to the dry weight of mineral matter, of at least one fluoride ion-containing compound is used.

13. Use according to claim 1, characterised in that the fluoride ion-containing compound on the one hand, and the (meth)acrylic acid homopolymer and/or copolymer and/or the phosphate compound, and/or the cationic polymer, on the other hand, are introduced simultaneously or in a sequential manner.

14. Use according to claim 1, characterised in that the fluoride ion-containing compound, firstly, and the (meth)acrylic acid homopolymer and/or copolymer, and/or the phosphate compound, and/or the cationic polymer, secondly, are introduced simultaneously, both in the form of an aqueous suspension and/or an aqueous solution and/or of dry powder, or are introduced simultaneously and in a blend, where the said blend is an aqueous suspension and/or an aqueous solution and/or a dry powder.

15. Use according to claim 1, characterised in that the fluoride ion-containing compound, firstly, is introduced in the form of a dry powder and/or in the form of an aqueous suspension and/or in the form of an aqueous solution, and in that the (meth)acrylic acid homopolymer and/or copolymer, and/or the phosphate compound, and/or the cationic polymer, secondly, is introduced in the form of an aqueous solution and/or in the form of dry powder when these two compounds are introduced sequentially, i.e. one after the other, whatever the order in which they are introduced.

16. Use according to claim 1, characterised in that the (meth)acrylic acid homopolymer and/or copolymer is obtained by processes of radical polymerisation in solution, in a direct or reverse emulsion, in suspension or in precipitation, in the presence of catalytic systems and transfer agents, or again by controlled radical polymerisation processes such as the method known as Reversible Addition Fragmentation Transfer (RAFT), the method known as Atom Transfer Radical Polymerization (ATRP), the method known as Nitroxide Mediated Polymerization (NMP), the method known as Macromolecular Design via Interchange of Xanthates (MADIX), or again the method known as Cobaloxime Mediated Free Radical Polymerization.

17. Use according to claim 1, characterised in that the (meth)acrylic acid homopolymer and/or copolymer may be, before or after the total or partial neutralisation reaction, treated and separated into several phases, according to static or dynamic processes, by one or more polar solvents belonging preferentially to the group constituted by water, methanol, ethanol, propanol, isopropanol, the butanols, acetone, tetrahydrofuran or their blends.

18. Use according to claim 1, characterised in that the aqueous suspension of mineral matter containing PCC contains at least one PCC of the rhombohedron, scalenohedron, vateric, aragonitic type, or their blends.

19. Use according to claim 1, characterised in that the aqueous suspension of mineral matter containing PCC may possibly contain at least one other mineral matter chosen from among natural calcium carbonate, the dolomites, kaolin, talc, gypsum, lime, magnesia, titanium dioxide, satin white, aluminium trioxide, or again aluminium trihydroxide, the silicas, mica and a blend of these fillers one with another, such as talc-calcium carbonate blends, calcium carbonate-kaolin blends, or again blends of calcium carbonate with aluminium trihydroxide or aluminium trioxide, or again blends with synthetic or natural fibres, or again mineral costructures such as talc-calcium carbonate costructures or talc-titanium dioxide costructures, or their blends, and preferentially in that it is a natural calcium carbonate which is preferentially chosen from among marble, calcite, chalk or their blends.

20. Aqueous suspensions of mineral matter containing PCC, and also containing as a dispersing agent the combination:
of at least one (meth)acrylic acid homopolymer and/or copolymer, and/or at least one phosphate compound, and/or at least one cationic polymer,
and of at least one fluoride ion-containing compound.

21. Aqueous suspensions of mineral matter according to claim 20, characterised in that the fluoride ion-containing compound is chosen from among the ammonium and/or phosphonium fluorides and/or from among the compounds NaF, HF, KF, NaHF₂, H₂SiF₆, HKF₂, FeF₂, PbF₂, HNH₄F₂ and their blends, and preferentially from among the compounds NaF, HF, KF, H₂SiF₆, HKF₂, and their blends, and in that it is preferentially the compound NaF and HF and their blends.

22. Aqueous suspensions of mineral matter according to claim 20, characterised in that the (meth)acrylic acid copolymer has at least one other monomer chosen from among at least:
a) another anionic monomer,
b) and/or at least one cationic monomer,
c) and/or at least one non-ionic monomer,

23. Aqueous suspensions of mineral matter according to claim 22, characterised in that the other anionic monomer a) is chosen from among an anionic monomer with ethylenic unsaturation and with a monocarboxylic function in the acid state or the acid-salt state, chosen from among the monomers with ethylenic unsaturation and a monocarboxylic function, and preferentially from among acrylic, methacrylic, crotonic, isocrotonic, cinnamic acid, or the diacid hemiesters such as the C₁ to C₄ monoesters of maleic or itaconic acids, or chosen from among the monomers with ethylenic unsaturation and with a dicarboxylic function in the acid or acid-salt state, and preferentially from among itaconic, maleic, fumaric, mesaconic acid, or again the anhydrides of carboxylic acids, such as maleic anhydride, or chosen from among the monomers with ethylenic unsaturation and a sulfonic function in the acid or acid-salt state, and preferentially from among acrylamido-2-methyl-2-propane-sulphonic acid, sodium methallylsulphonate, vinyl sulphonic acid and styrene sulphonic acid, or again chosen from among the monomers with ethylenic unsaturation and with a phosphoric function in the acid or acid-salt state such as vinyl phosphoric acid, ethylene glycol methacrylate phosphate, propylene glycol methacrylate phosphate, ethylene glycol acrylate phosphate, propylene glycol acrylate phosphate and their ethoxylates, or again chosen from among the monomers with ethylenic unsaturation and with a phosphonic function in the acid or acid-salt state, and is preferentially vinyl phosphonic acid, or their blends.

24. Aqueous suspensions of mineral matter according to claim 22, characterised in that the cationic monomer b) is chosen from among the quaternary ammoniums, and preferentially from among [2-(methacryloyloxy)ethyl]trimethyl ammonium chloride or sulphate, [2-(acryloyloxy)ethyl]trimethyl ammonium chloride or sulphate, [3-(acrylamido)propyl]trimethyl ammonium chloride or sulphate, dimethyl diallyl ammonium chloride or sulphate, [3-(methacrylamido)propyl]trimethyl ammonium chloride or sulphate, or their blends.

25. Aqueous suspensions of mineral matter according to claim 22, characterised in that the non-ionic monomer c) is chosen from among N-[3-(dimethylamino) propyl]acrylamide or N-[3-(dimethylamino)propyl]methacrylamide, the unsaturated esters such as N-[2-(dimethylamino)ethyl]methacrylate, or N-[2-(dimethylamino)ethyl]acrylate, or from among acrylamide or methacrylamide and their blends, the alkyl acrylates or methacrylates, the vinylic monomers, and preferentially vinyl acetate, vinylpyrrolidone, styrene, alphamethylstyrene and their derivatives, or the monomers of the following formula (I): 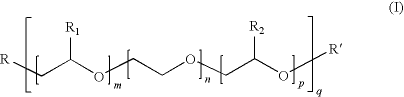
where:
m and p represent a number of alkylene oxide units of less than or equal to 150,
n represents a number of ethylene oxide units of less than or equal to 150,
q represents a whole number at least equal to 1 and such that 5≦(m+n+p)q≦150, and preferentially such that 15≦(m+n+p)q≦120,
R₁ represents hydrogen or the methyl or ethyl radical,
R₂ represents hydrogen or the methyl or ethyl radical,
R represents a radical containing an unsaturated polymerisable function, preferentially belonging to the group of vinylics, or to the group of acrylic, methacrylic, maleic, itaconic, crotonic or vinylphthalic esters, or to the group of unsaturated urethanes such as acrylurethane, methacrylurethane, α-α′ dimethyl-isopropenyl-benzylurethane, allylurethane, or to the group of allylic or vinylic ethers, whether or not substituted, or again to the group of ethylenically unsaturated amides or imides,
R′ represents hydrogen or a hydrocarbonated radical having 1 to 40 carbon atoms.

26. Aqueous suspensions of mineral matter according to claim 20, characterised in that the (meth)acrylic acid homopolymer and/or copolymer used is neutralised, totally or partially, by a neutralisation agent chosen from among the sodium or potassium hydroxides, the calcium or magnesium hydroxides and/or oxides, ammonium hydroxide, or their blends, and very preferentially by a neutralisation agent which is sodium hydroxide.

27. Aqueous suspensions of mineral matter according to claim 20, characterised in that the cationic polymer consists of at least one monomer chosen from among the quaternary ammoniums, and preferentially from among [2-(methacryloyloxy)ethyl]trimethyl ammonium chloride or sulphate, [2-(acryloyloxy)ethyl]trimethyl ammonium chloride or sulphate, [3-(acrylamido)propyl]trimethyl ammonium chloride or sulphate, dimethyl diallyl ammonium chloride or sulphate, [3-(methacrylamido)propyl]trimethyl ammonium chloride or sulphate, or their blends.

28. Aqueous suspensions of mineral matter according to 20, characterised in that the phosphate compound is chosen from among the polyphosphates and preferentially from among the tripolyphosphates, or the hexametaphosphates or the pyrophosphates, of sodium or of potassium, or their blends.

29. Aqueous suspensions of mineral matter according to claim 20, characterised in that they contain between 0.1% and 5.0%, by dry weight relative to the dry weight of mineral matter, of at least one (meth)acrylic acid homopolymer and/or copolymer and/or at least one phosphate compound and/or at least one cationic polymer.

30. Aqueous suspensions of mineral matter according to claim 20, characterised in that they contain between 0.01% and 0.5%, and preferentially between 0.05% and 0.25%, by dry weight relative to the dry weight of mineral matter, of at least one fluoride ion-containing compound.

31. Aqueous suspensions of mineral matter according to claim 20, characterised in that the (meth)acrylic acid homopolymer and/or copolymer is obtained by processes of radical copolymerisation in solution, in a direct or reverse emulsion, in suspension or in precipitation in solvents, in the presence of catalytic systems and transfer agents, or again by controlled radical polymerisation processes such as the method known as Reversible Addition Fragmentation Transfer (RAFT), the method known as Atom Transfer Radical Polymerization (ATRP), the method known as Nitroxide Mediated Polymerization (NMP), the method known as Macromolecular Design via Interchange of Xanthates (MADIX), or again the method known as Cobaloxime Mediated Free Radical Polymerization.

32. Aqueous suspensions of mineral matter according to claim 20, characterised in that the (meth)acrylic acid homopolymer and/or copolymer may be, before or after the total or partial neutralisation reaction, treated and separated into several phases, according to static or dynamic processes, by one or more polar solvents belonging preferentially to the group constituted by water, methanol, ethanol, propanol, isopropanol, the butanols, acetone, tetrahydrofuran or their blends.

33. Aqueous suspensions of mineral matter according to claim 20, characterised in that they contain at least one PCC of the rhombohedron, scalenohedron, vateric or aragonitic type, or their blends.

34. Aqueous suspensions of mineral matter according to claim 20, characterised in that they may possibly contain at least a mineral matter other than PCC, chosen from among natural calcium carbonate, the dolomites, kaolin, talc, gypsum, lime, magnesia, titanium dioxide, satin white, aluminium trioxide, or again aluminium trihydroxide, the silicas, mica and a blend of these fillers one with another, such as talc-calcium carbonate blends, calcium carbonate-kaolin blends, or again blends of calcium carbonate with aluminium trihydroxide or aluminium trioxide, or again blends with synthetic or natural fibres, or again mineral costructures such as talc-calcium carbonate costructures or talc-titanium dioxide costructures, or their blends, and preferentially in that it is a natural calcium carbonate which is preferentially chosen from among marble, calcite, chalk or their blends.

35. A process for manufacturing pigments containing PCC, characterised in that an aqueous suspension of mineral matter containing PCC according to claim 20 undergoes at least one additional treatment stage, chosen from among:
a stage of blending with another aqueous dispersion and/or suspension containing a mineral matter, which is preferentially natural calcium carbonate or kaolin, or their blends,
a grinding stage,
a stage of co-grinding with another mineral matter, which is preferentially natural calcium carbonate,
a stage of mechanical and/or thermal concentration,
a drying stage.

36. An aqueous suspension of mineral matter containing PCC, characterised in that it is obtained by the process according to claim 35.

37. A dry pigment containing PCC, characterised in that it is obtained by the process according to claim 35.

38. Use of the aqueous suspensions of mineral matter containing PCC according to claim 20, in a process to manufacture aqueous formulations of mineral matter or of dry products containing mineral matter.

39. Use of the aqueous suspensions of mineral matter containing PCC according to claim 20, in a process to manufacture paper coatings.

40. Use of the aqueous suspensions of mineral matter containing PCC according to claim 20, in a process to manufacture paper sheet.

41. Use of the aqueous suspensions of mineral matter containing PCC according to claim 20, in a process to manufacture paint.

42. Use of the aqueous suspensions of mineral matter containing PCC according to claim 20, in a process to manufacture plastics or rubbers.
